(19) United States
(12) Patent Application Publication
(10) Pub. No.: US 2025/0182978 A1
(43) Pub. Date: Jun. 5, 2025

(54) TANTALUM CAPACITOR

(71) Applicant: SAMSUNG ELECTRO-MECHANICS CO., LTD., Suwon-si (KR)

(72) Inventors: Seong Chan Park, Suwon-si (KR); Jung Eun Noh, Suwon-si (KR); Yee Na Shin, Suwon-si (KR); Hyun Bok Kwon, Suwon-si (KR); Sol I Kwon, Suwon-si (KR); Yong Choon Park, Suwon-si (KR)

(73) Assignee: SAMSUNG ELECTRO-MECHANICS CO., LTD., Suwon-si (KR)

(21) Appl. No.: 18/923,134

(22) Filed: Oct. 22, 2024

(30) Foreign Application Priority Data
Nov. 30, 2023 (KR) 10-2023-0170584

(51) Int. Cl. H01G 9/052

(52) U.S. Cl. CPC H01G 9/0525

(57) ABSTRACT

A tantalum capacitor includes a tantalum body including a tantalum core and a conductive polymer layer disposed on the tantalum core, a molded portion including a fifth surface and a sixth surface opposing each other in a first direction, a third surface and a fourth surface opposing each other in a second direction, and a first surface and a second surface opposing each other in a third direction, the molded portion formed to surround the tantalum body, an anode portion including a first ceramic layer in contact with the tantalum body and an electrode layer disposed on the first ceramic layer, and a cathode portion connected to the tantalum body, and spaced apart from the anode portion.

### CROSS-REFERENCE TO RELATED APPLICATION(S)

This application claims benefit of priority to Korea patent Application No. 10-2023-0170584 filed on Nov. 30, 2023 in the Korean Intellectual Property Office, the disclosure of which is incorporated herein by reference in its entirety.

### TECHNICAL FIELD

The present disclosure relates to a tantalum capacitor, and more particularly, to a tantalum capacitor having improved moisture resistance and connection reliability, and improved capacitance.

Tantalum (Ta) is a metal widely used across industries, including in the electricity and electronics, machinery, chemical engineering, medicine, space, and military industries, due to mechanical and physical characteristics thereof, such as a high melting point and excellent ductility and corrosion resistance.

In particular, a material formed of tantalum (Ta) is currently widely used as an anode material for small capacitors due to characteristics thereof which form the most stable anodized oxide film among all metals.

Moreover, the use of tantalum materials has rapidly increased on a yearly basis due to the recent rapid development of IT industries, such as electronics and information and communication.

Tantalum capacitors use a structure using an internal lead frame to connect a tantalum body and electrodes. In this case, if sufficient adhesion between the internal lead frame and a molded portion is not secured, an interfacial defect may occur and moisture may penetrate through the interface. This degrades the characteristics of tantalum capacitors in high temperature and high humidity environments and affects reliability.

### SUMMARY

An aspect of the present disclosure is to provide a tantalum capacitor having excellent reliability by minimizing an interface between a frame and a molded portion.

Another aspect of the present disclosure is to provide a tantalum capacitor having increased storage capacity.

According to an aspect of the present disclosure, provided is a tantalum capacitor, the tantalum capacitor including, a tantalum body including a tantalum core and a conductive polymer layer disposed on the tantalum core, a molded portion including a fifth surface and a sixth surface opposing each other in a first direction, a third surface and a fourth surface opposing each other in a second direction, and a first surface and a second surface opposing each other in a third direction, the molded portion disposed to surround the tantalum body, an anode portion including a first ceramic layer in contact with the tantalum body and an electrode layer disposed on the first ceramic layer, and a cathode portion connected to the tantalum body, and spaced apart from the anode portion.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view of a tantalum capacitor according to a first embodiment of the present disclosure;

FIG. 2 is a transmittance diagram of the tantalum capacitor in FIG. 1 viewed in a second direction;

FIG. 3 is a cross-sectional view taken along line I-I′ in FIG. 1;

FIG. 4 is a perspective view illustrating a structure of the anode portion in FIG. 1;

FIG. 5 is a perspective view illustrating a bonding structure between the anode portion and the tantalum body in FIG. 1;

FIGS. 6 to 9 are cross-sectional views illustrating modified examples of the tantalum capacitor according to the first embodiment;

FIG. 10 is a perspective view of a tantalum capacitor according to a second embodiment of the present disclosure;

FIG. 11 is a transmittance diagram of the tantalum capacitor in FIG. 10 viewed in a second direction;

FIG. 12 is a cross-sectional view taken along line II-II′ in FIG. 10;

FIG. 13 is a cross-sectional view illustrating a modified example of a tantalum capacitor according to the second embodiment;

FIG. 14 is a cross-sectional view illustrating another modified example of the tantalum capacitor according to the second embodiment; and

FIG. 15 is a cross-sectional view illustrating a conventional tantalum capacitor.

### DETAILED DESCRIPTION

Hereinafter, exemplary embodiments of the present disclosed concept will be described in detail with reference to the accompanying drawings. The disclosed concept may, however, be exemplified in many different forms and should not be construed as being limited to the specific exemplary embodiments set forth herein. Rather, these exemplary embodiments are provided so that this disclosure will be thorough and complete, and will fully convey the scope of the disclosed concept to those skilled in the art. In the drawings, the shapes and dimensions of elements may be exaggerated for clarity, and the same reference numerals will be used throughout to designate the same or like elements.

Hereinafter, exemplary embodiments in the present disclosure will be described with reference to the accompanying drawings.

In the drawing, an X-direction may be defined as a first direction, an L-direction, or a length direction, a Y-direction may be defined as a second direction, a W direction, or a width direction, and a Z-direction may be defined as a third direction, a T-direction, or a thickness direction.

### First Embodiment

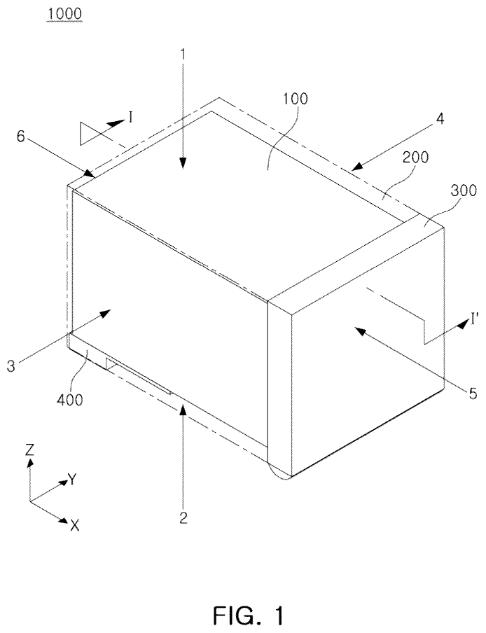

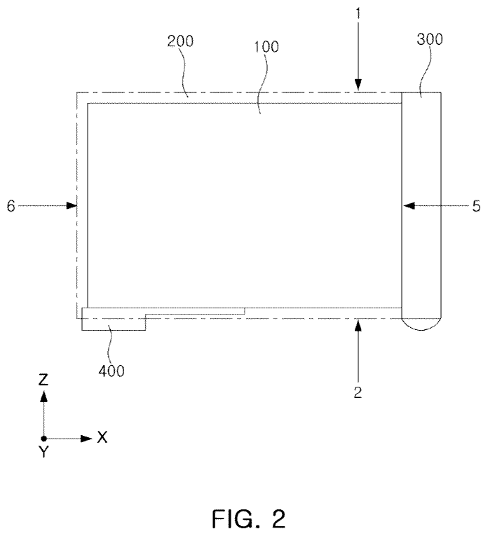

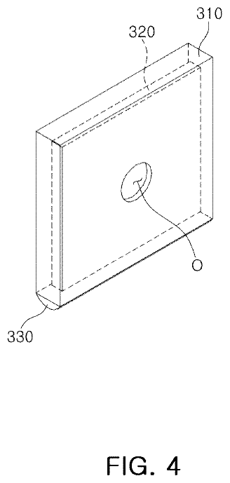

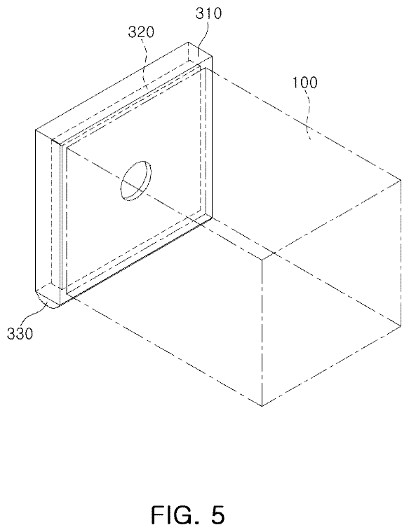

FIG. 1 is a perspective view of a tantalum capacitor according to a first embodiment of the present disclosure. FIG. 2 is a transmittance diagram of the tantalum capacitor in FIG. 1 viewed in a second direction. FIG. 4 is a perspective view illustrating a structure of the anode portion in FIG. 1. FIG. 5 is a perspective view illustrating a bonding structure between the anode portion and the tantalum body in FIG. 1.

Referring to FIGS. 1 and 2, a tantalum capacitor 1000 of the present embodiment may include a tantalum body 100, a molded portion 200, an anode portion 300, and a cathode portion 400.

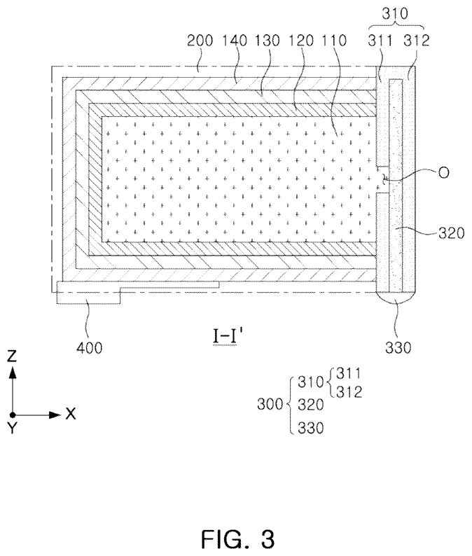

Referring to FIG. 3, the tantalum body 100 will be described. FIG. 3 is a cross-sectional view taken along line I-I′ in FIG. 1.

Referring to FIG. 3, the tantalum body 100 of the present disclosure may include a tantalum core 110 formed by sintering a molded body including metal powder, a conductive polymer layer 120 disposed on the tantalum core 110, a carbon layer 130 disposed on the conductive polymer layer 120, and a silver (Ag) layer 140 disposed on the carbon layer 130.

The tantalum capacitor may not include a tantalum wire. This will be described in detail in the description of an anode portion 300 which will be described later.

The tantalum core 110 may be formed by sintering a molded body including metal powder and a binder.

Specifically, the tantalum core 110 may be manufactured by mixing metal powder, a binder, and a solvent at a certain ratio, stirring the mixture, compressing the mixed powder to form a rectangular parallelepiped, and then sintering the same under high temperature and high vibration.

The metal powder is not particularly limited as long as it may be used in the tantalum core 110 of the tantalum capacitor 1000 according to an embodiment of the present disclosure, and may be tantalum (Ta) powder. However, the present disclosure is not limited thereto, and the metal powder may be one or more selected from the group consisting of aluminum (Al), niobium (Nb), vanadium (V), titanium (Ti), and zirconium (Zr), and accordingly, an aluminum element, a niobium element, and the like, instead of the tantalum element, may also be used.

The binder is not limited and may be, for example, a cellulose-based binder.

The cellulose-based binder may be one or more selected from the group consisting of nitrocellulose, methyl cellulose, ethyl cellulose, and hydroxy propyl cellulose.

According to an embodiment of the present disclosure, a dielectric oxide layer may be formed as an insulating layer on the tantalum core 110. That is, the dielectric oxide layer may be formed by growing an oxide film (Ta₂O₅) on a surface of the tantalum core 110 through a formation process using an electrochemical reaction. Here, the dielectric oxide layer changes the tantalum core 110 into a dielectric. In addition, a conductive polymer layer 120 having a negative polarity may be applied and formed on the dielectric oxide layer.

The conductive polymer layer 120 is not particularly limited, and may include for example, a conductive polymer.

Specifically, the conductive polymer may be formed using chemical polymerization or electropolymerization using EDOT (3,4-ethylenedioxythiophene), pyrrole monomer, or polypyrrole, and then may be formed as a cathode layer having a conductive polymer cathode on an external surface of the tantalum core 110 formed as an insulating layer.

That is, the conductive polymer layer 120 may be formed using a polymer slurry, and the polymer slurry may include at least one of polypyrrole, polyaniline, or EDOT (3,4-ethylenedioxythiophene). In addition, the conductive polymer layer 120 may also include PEDOT:PSS (poly(3,4-ethylenedioxythiophene):poly(styrenesulfonate)). PEDOT:PSS may be manufactured by oxidative polymerization of EDOT using polystyrene sulfonate (PSS) as a template to balance charge.

Meanwhile, the carbon layer 130 may be laminated on the conductive polymer layer 120, and may be laminated by dissolving carbon powder in an organic solvent including an epoxy-based resin, dipping the tantalum core 110 into the solution in which the carbon powder is dissolved, and then drying the same at a predetermined temperature to volatilize the organic solvent.

In addition, the carbon layer 130 may serve to prevent silver (Ag) ions from passing therethrough.

Next, a silver (Ag) layer 140 formed of a silver (Ag) paste may be included on an upper surface of the carbon layer 130.

The silver (Ag) layer 140 may be laminated on the outside of the carbon layer 130 to improve conductivity.

In addition, the silver (Ag) layer 140 may facilitate electrical connection for polarity transfer by improving conductivity for the polarity of the cathode layer.

The molded portion 200 covers the tantalum body 100 to serve to protect the tantalum body 100.

The molded portion 200 includes a fifth surface 5 and a sixth surface 6 opposing each other in the first direction (X-direction), a third surface 3 and a fourth surface 4 opposing each other in the second direction (Y-direction), and a first surface 1 and a second surface 2 opposing each other in the third direction (Z-direction). As an example, the molded portion 200 may have a hexahedral shape, but the present disclosure is not necessarily limited thereto.

The molded portion 200 may be formed by transfer molding a resin such as EMC (epoxy molding compound) to surround the tantalum body 100.

The anode portion 300 may include a first ceramic layer 311 in contact with the tantalum body 100 and an electrode layer 320 disposed on the first ceramic layer 311. The first ceramic layer 311 is in contact with the tantalum body 100. Specifically, the first ceramic layer 311 may contact one surface of the tantalum body 100. The first ceramic layer 311 may contact the conductive polymer layer 120, the carbon layer 130, and the silver (Ag) layer 140 of the tantalum body 100.

The first ceramic layer 311 may include at least one opening O, and a portion of the tantalum core 110 may be disposed in the at least one opening O. By disposing a portion of the tantalum core 110 in the at least one opening, the tantalum core 110 and the electrode layer 320 of the anode portion may be electrically connected. That is, since the anode portion 300 of the tantalum capacitor according to the present embodiment is in direct contact with the tantalum body 100, the tantalum wire may be omitted as compared to the conventional tantalum capacitor.

The anode portion may further include a second ceramic layer 312 disposed on the electrode layer 320. The second ceramic layer 312 may cover the electrode layer 320 and can prevent the electrode layer 320 from being exposed to the external surface of the tantalum capacitor.

Referring to FIGS. 3 and 4, the first ceramic layer 311, the electrode layer 320, and the second ceramic layer 312 may be disposed in that order in the first direction (X-direction). That is, the electrode layer 320 may be disposed or stacked between the plurality of ceramic layers 311 and 312.

Meanwhile, the anode portion 300 and a cathode portion 400, which will be described later, may be spaced apart in the first direction (X-direction), but the present disclosure is not necessarily limited thereto, and may be spaced apart in the second direction (Y-direction). In this case, the anode portion 300 may be disposed in the order of the first ceramic layer 311, the electrode layer 320, and the second ceramic layer 312 in the second direction (Y-direction).

The ceramic layers 311 and 312 may include ceramic powder or barium titanate (BaTiO₃)-based powder, but the present disclosure is not limited thereto. For example, the ceramic powder may be at least one of strontium titanate (SrTiO₃)-based ceramic powder, calcium titanate (CaTiO₃)-based ceramic powder, and calcium zirconate (CaZrO₃)-based ceramic powder, and a portion of the ceramic powder may be solid-solubilized by substituting barium (Ba) and/or titanium (Ti) of barium titanate (BaTiO₃) with other elements (e.g., rare-earth elements). In addition, various ceramic additives (e.g. MgO, Al₂O₃, SiO₂, Zno), organic solvents, plasticizers, binders, dispersants, and the like may be added to the ceramic powder. For example, the ceramic powder may include polyvinyl alcohol (PVA), polyvinyl butyral (PVB), acrylic resin, or the like as a binder.

The ceramic layers 311 and 312 may be prepared in the form of a sheet by applying and drying a slurry containing powder such as barium titanate (BaTiO₃) on a carrier film.

The ceramic sheet may be formed by mixing ceramic powder, binder, and a solvent to produce a slurry, and manufacturing the slurry into a sheet with a thickness of several ums using a doctor blade method, but the present disclosure is not limited thereto.

The electrode layer 320 is disposed between the ceramic layers 311 and 312. The electrode layer 320 is connected to the tantalum body 100 and functions as an electrode.

Referring to FIGS. 3 and 4, the electrode layer 320 may be surrounded by a plurality of ceramic layers 311 and 312. Contact with the molded portion 200 may be blocked by the plurality of ceramic layers 311 and 312. That is, the electrode layer 320 may be spaced apart from the molded portion 200.

As will be described later, after disposing tantalum powder for forming the tantalum core 110 in an opening of the ceramic layer, the tantalum core 110 and the anode portion 300 may be sintered simultaneously. Accordingly, the electrode layer 320 and the tantalum core 110 can contact each other through the opening of the ceramic layer. The electrode layer 320 and the tantalum core 110 may be in direct contact without using the tantalum wire.

Referring to FIG. 3, a lower surface of the electrode layer 320 extends from the ceramic layers 311 and 312 based on FIG. 3, so the anode portion 300 may function as a terminal when mounted on a substrate.

A material forming the electrode layer 320 is not particularly limited, and any material having excellent conductivity may be used. For example, the material may include one or more selected from the group consisting of Ni (nickel), Ta (tantalum), Fe (iron), Nb (niobium), Co (cobalt), Ir (iridium), and Cr (chromium). In addition, the electrode layer 320 may be formed by printing a paste including one or more of Ni (nickel), Ta (tantalum), Fe (iron), Nb (niobium), Co (cobalt), Ir (iridium), Cr (chromium), and alloys thereof on the first ceramic layer 311. Specific printing methods include a screen printing method, a gravure printing method, an inkjet printing method, and the like, but the present disclosure is not limited thereto.

The anode portion 300 can be formed by laminating a ceramic layer with a conductive paste printed thereon, and compressing the same. Thereafter, tantalum powder for forming the tantalum core 110 is placed in the opening of the ceramic layer, and then the tantalum core 110 and the anode portion 300 may be sintered simultaneously.

When the electrode layer 320 is formed of a metal having a similar sintering temperature as the tantalum powder, the anode portion 300 and the tantalum core 110 may be sintered simultaneously. In this case, an alloy with tantalum (Ta) can be formed by sintering, and bonding strength of the anode portion 300 and the tantalum body 100 may be increased. As an example, when the electrode layer 320 includes iron (Fe), nickel (Ni), and SUS304, the bonding strength with the tantalum body may be increased.

The anode portion 300 may further include a plating layer 330 connected to the electrode layer in a third direction. The plating layer 330 may be formed of a conductive material such as copper (Cu), aluminum (Al), silver (Ag), tin (Sn), gold (Au), nickel (Ni), lead (Pb), chromium (Cr), titanium (Ti), or an alloy thereof, but the present disclosure is not limited thereto. The plating layer 330 may be formed as a single layer. When the electrode layer 320 includes nickel (Ni), the plating layer may be formed as a single layer. For example, the plating layer 330 may be a tin (Sn) plating layer. However, the present disclosure is not limited thereto, and the plating layer 330 may be formed as a plurality of layers, as in a modified example which will be described later.

The plurality of ceramic layers 311 and 312 constituting the anode portion are in a sintered state, and a boundary between the adjacent ceramic layers may be integrated with each other such that the boundary may not be readily apparent without a scanning electron microscope (SEM).

In the present embodiment, the plurality of integrated ceramic layers 311 and 312 may be referred to as a dielectric 310 for convenience. In addition, the electrode layer 320 may be an electrode sintered inside the dielectric 310.

The dielectric 310 may be disposed on one surface of the tantalum body 100, and the electrode layer 320 may be disposed inside the dielectric 310.

The electrode layer 320 may extend to one surface of the dielectric 310 (a lower surface thereof based on FIG. 3).

The tantalum body 100 may penetrate a portion of the dielectric 310 and be connected to the electrode layer 320. The electrode layer 320 may be spaced apart from the molded portion 200.

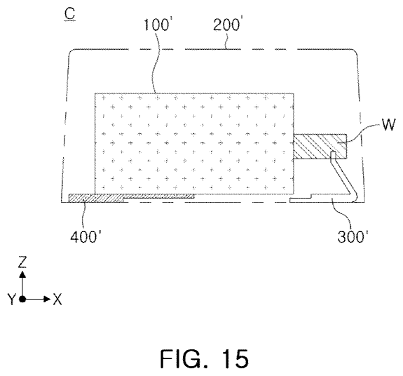

FIG. 15 is a cross-sectional view illustrating a conventional tantalum capacitor. In a conventional tantalum capacitor, when sufficient adhesion between the lead frame 300′ and the molded portion 200′ is not secured, an interfacial defect occurs and moisture penetrates through the interface. This degrades the characteristics of tantalum capacitors in high and temperature high humidity environments and affects reliability. In addition, since in the conventional tantalum capacitor, the tantalum body and an external electrode are connected through a tantalum wire (W), there is a problem in that the storage capacity is low compared to the size of the tantalum capacitor.

On the other hand, the electrode layer 320 of the tantalum capacitor according to the present embodiment is blocked from the contact with the molded portion 200 by the ceramic layers 311 and 312, so moisture penetration through the interface may be minimized, and a tantalum capacitor having excellent reliability may be provided.

In addition, water transmittance of ceramic is much lower than that of EMC. [Table 1] below shows the results of measuring transmittance of EMC and transmittance of ceramic sheets under conditions of 37.8° C. and 100% RH.

TABLE 1

| | | | Thick- | Transmittance | Transmissivity |
|---|---|---|---|---|---|
| Sample | | | ness | (WVTR) | (WVTR*Thickness) |
| name | | Conditions | (μm) | [mg/m²-day] | [mg/[m-day]] |
| 1 | EMC | 37.8° C./ | 100 | 2179 | 0.2179 |
| | | 100% RH | | | |
| 2 | Ceramic | 37.8° C./ | 15 | 0 | 0 |
| | sheet | 100% RH | | | |

Referring to [Table 1], transmittance of a ceramic sheet is substantially 0. In other words, penetration of moisture through the ceramic layer may be almost impossible, so the anode portion may be miniaturized. As an example, a thickness of the anode portion may be 100 μm or less, and more specifically, may be 30 μm or less. Since a volume of the anode portion is relatively reduced, the storage capacity of the tantalum body 100 may be maximized.

In addition, since the anode portion 300 and the tantalum body 100 are in direct contact with each other, the tantalum wire can be omitted, and the storage capacity can be increased by maximizing a volume of the tantalum capacitor.

In addition, the anode portion 300 and the tantalum core 110 may be sintered at the same time, and in this case, an alloy may be formed between the metal of the electrode layer 320 and tantalum (Ta) by sintering, and accordingly, the bonding strength between the anode portion 300 and the tantalum body 100 may be increased.

The cathode portion 400 may be connected to the tantalum body 100 to serve as a terminal when mounted on a board. The cathode portion 400 may be disposed to be spaced apart from the anode portion 300 in the first direction (X-direction). The cathode portion 400 may be exposed to the second surface 2 of the molded portion 200. The cathode portion 400 is exposed to the bottom of the molded portion 200 and to serve as a terminal when mounted on a board, and can function as a cathode of the tantalum capacitor 1000 according to the present disclosure.

The cathode portion 400 may be in the form of a lead frame. That is, in the case of the tantalum capacitor according to the first embodiment, the cathode portion 400 may include a cathode lead frame. However, the present disclosure is not limited thereto, and the cathode portion 400 may be formed of a plating layer, as in a second embodiment, which will be described later.

The cathode lead frame 400 may be formed of a conductive metal such as nickel/iron alloys.

Meanwhile, although not shown in the drawings, the tantalum capacitor according to an embodiment of the present disclosure may further include a conductive adhesive layer to bond the cathode lead frame 400 and the tantalum body 100. Such a conductive adhesive layer may be formed, for example, by applying and curing a certain amount of a conductive adhesive containing, for example, an epoxy-based thermosetting resin and conductive metal powder such as silver (Ag), but the present disclosure is not limited thereto.

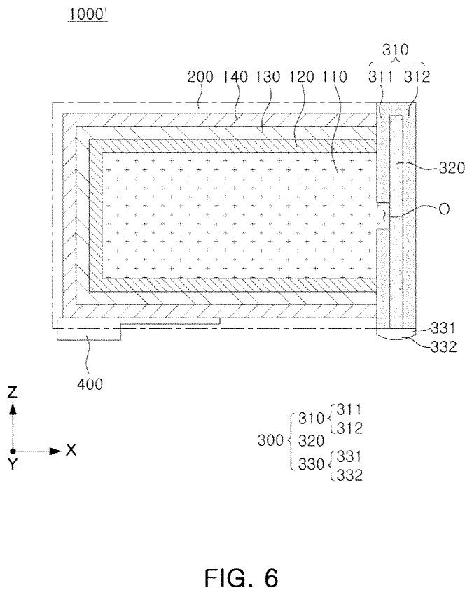

FIG. 6 is a cross-sectional view illustrating a modified example 1000′ of a tantalum capacitor according to a first embodiment.

A plating layer 330 of the modified example 1000′ of the tantalum capacitor according to the first embodiment may be formed of a plurality of layers. Specifically, the plating layer 330 may include a first plating layer 331 in contact with the electrode layer 320 and a second plating layer 332 disposed on the first layer. Here, the first layer may be a nickel (Ni) layer, and the second layer may be a tin (Sn) layer.

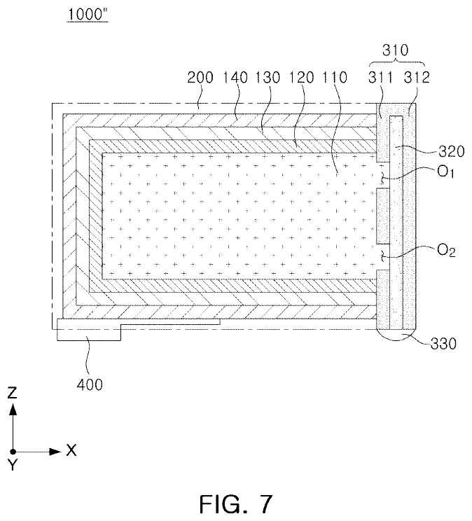

FIG. 7 is a cross-sectional view illustrating a modified example 1000″ of a tantalum capacitor according to a first embodiment.

A first ceramic layer 311 of the modified example 1000″ of the tantalum capacitor according to the first embodiment may include two or more openings. Referring to FIG. 7, the first ceramic layer 311 may include two openings O₁ and O₂, and it can be confirmed that the tantalum core 110 and the electrode layer 320 are connected through the two openings O₁ and O₂. The two openings O₁ and O₂ may be spaced apart in a third direction (Z direction), but the present disclosure is not necessarily limited thereto, and may be spaced apart in a second direction (Y direction). In addition, three or more openings may be formed.

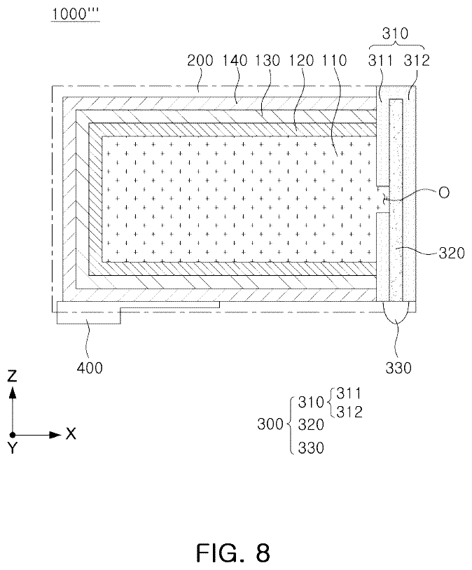

FIG. 8 is a cross-sectional view illustrating a modified example 1000′″ of a tantalum capacitor according to a first embodiment.

The molded portion 200 of a modified example 1000′″ of the tantalum capacitor according to the first embodiment may cover lower surfaces of the first and second ceramic layers 311 and 312. In this case, a volume of the anode portion 300 may be reduced to miniaturize the tantalum capacitor.

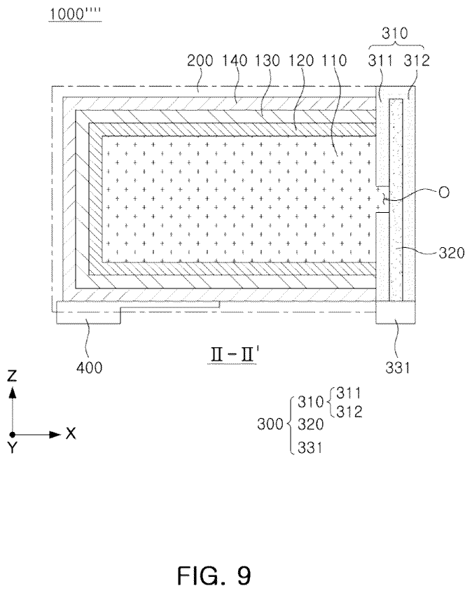

FIG. 9 is a cross-sectional view illustrating a modified example 1000″″ of a tantalum capacitor according to a first embodiment.

The modified example 1000″″ of the tantalum capacitor according to the first embodiment may further include an anode lead frame 331. That is, the anode lead frame 331, other than the plating layer, may be exposed to a lower surface of the molded portion 200 and to serve as a terminal when mounted on a board. The anode lead frame 331 may be formed of a conductive metal such as nickel/iron alloy.

### Second Embodiment

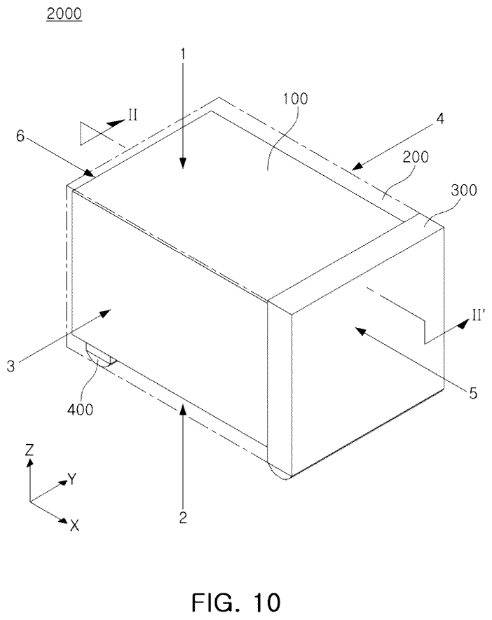

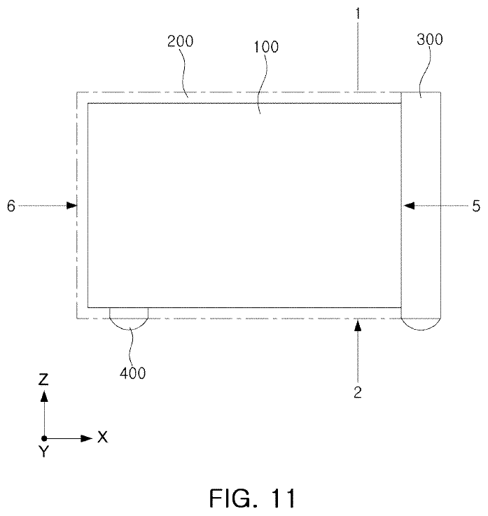

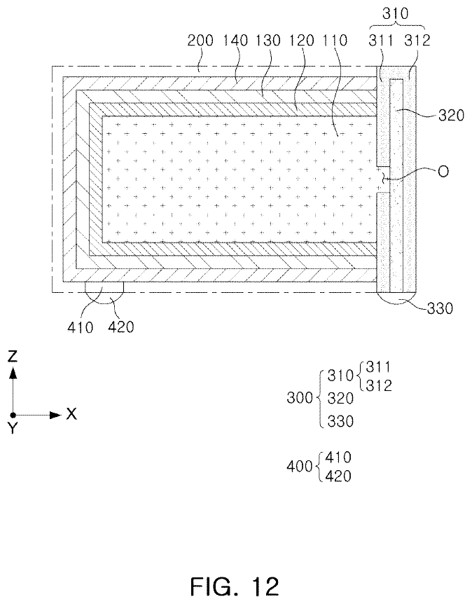

FIG. 10 is a perspective view of a tantalum capacitor according to a second embodiment of the present disclosure. FIG. 11 is a transmittance diagram of the tantalum capacitor in FIG. 10 viewed in a second direction. FIG. 12 is a cross-sectional view taken along line II-II′ in FIG. 10.

As compared to the first embodiment, the tantalum capacitor 2000 according to the second embodiment may have a cathode portion 400 formed of a plating layer instead of a lead frame. Specifically, the plating layer may include a first plating layer 410 and a second plating layer 420.

The plating layers 410 and 420 may be formed of copper (Cu), aluminum (Al), silver (Ag), tin (Sn), gold (Au), nickel (Ni), lead (Pb), chromium (Cr), titanium (Ti), or an alloy thereof, but the present disclosure is not limited thereto. For example, the plating layer may include a first plating layer 410 in contact with the silver (Ag) layer 140 of the tantalum body 100 and a second plating layer 420 disposed on the first layer. Here, the first plating layer may be a nickel (Ni) layer, and the second plating layer may be a tin (Sn) layer.

Except for the description of the cathode portion 400, the description in the first embodiment may be applied as it is, and detailed description is omitted as it is redundant.

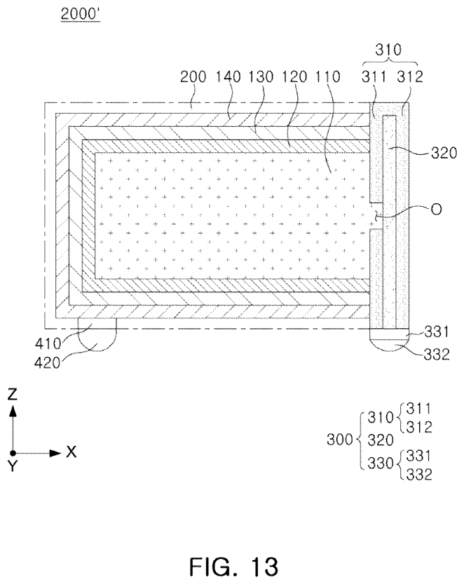

FIG. 13 is a cross-sectional view illustrating a modified example 2000′ of a tantalum capacitor according to a second embodiment.

Referring to FIG. 13, in the modified example 2000′ of the tantalum capacitor according to the second embodiment, a plating layer 330 of the anode portion may be formed of a plurality of layers. Specifically, the plating layer 330 may include a first plating layer 331 in contact with the electrode layer 320 and a second plating layer 332 disposed on the first layer. Here, the first layer may be a nickel (Ni) layer, and the second layer may be a tin (Sn) layer.

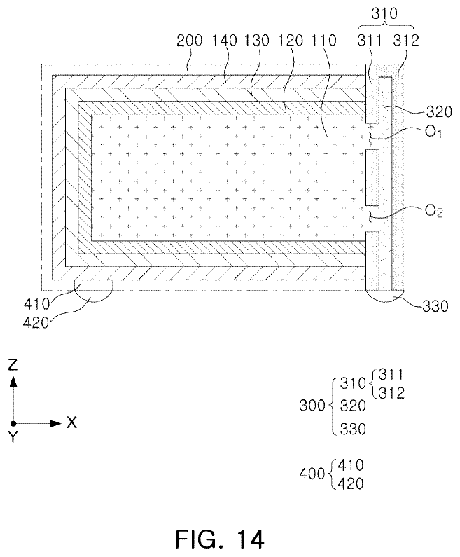

FIG. 14 is a cross-sectional view illustrating another modified example 2000″ of a tantalum capacitor according to a second embodiment.

A first ceramic layer 311 of another modified example 2000″ of the tantalum capacitor according to the second embodiment may include two or more openings. Referring to FIG. 14, the first ceramic layer 311 may include two openings O₁ and O₂, and it can be confirmed that the tantalum core 110 and the electrode layer 320 are connected through the two openings O₁ and O₂. The two openings O₁ and O₂ may be spaced apart in the third direction (Z direction), but the present disclosure is not necessarily limited thereto, and may be spaced apart in the second direction (Y direction). In addition, three or more openings may be formed.

As set forth above, one effect of the present disclosure is to provide a tantalum capacitor having excellent reliability by minimizing an interface between a frame and a molded portion.

Another effect of the present disclosure is to provide a tantalum capacitor having increased storage capacity.

While example exemplary embodiments have been illustrated and described above, it will be apparent to those skilled in the art that modifications and variations could be made without departing from the scope of the present disclosure as defined by the appended claims.

What is claimed is:

1. A tantalum capacitor, comprising:
a tantalum body including a tantalum core and a conductive polymer layer disposed on the tantalum core;
a molded portion including a fifth surface and a sixth surface opposing each other in a first direction, a third surface and a fourth surface opposing each other in a second direction, and a first surface and a second surface opposing each other in a third direction, the molded portion disposed to surround the tantalum body;
an anode portion including a first ceramic layer in contact with the tantalum body and an electrode layer disposed on the first ceramic layer; and
a cathode portion connected to the tantalum body, and spaced apart from the anode portion.

2. The tantalum capacitor of claim 1, wherein the anode portion: includes a second ceramic layer disposed on the electrode layer.

3. The tantalum capacitor of claim 2, wherein the first ceramic layer, the electrode layer, and the second ceramic layer are disposed in the first direction.

4. The tantalum capacitor of claim 1, wherein the electrode layer comprises one or more selected from the group consisting of nickel (Ni), tantalum (Ta), iron (Fe), niobium (Nb), cobalt (Co), iridium (Ir), and chromium (Cr).

5. The tantalum capacitor of claim 1, wherein the first ceramic layer comprises at least one opening, and
a portion of the tantalum core is disposed in the at least one opening.

6. The tantalum capacitor of claim 5, wherein the tantalum core and the electrode layer are connected through the at least one opening.

7. The tantalum capacitor of claim 1, wherein the anode portion further includes a plating layer connected to the electrode layer in the third direction.

8. The tantalum capacitor of claim 7, wherein the cathode portion comprises a first plating layer and a second plating layer disposed on the first plating layer.

9. The tantalum capacitor of claim 1, wherein the electrode layer is spaced apart from the molded portion.

10. The tantalum capacitor of claim 1, wherein the tantalum body further includes a carbon layer disposed on the conductive polymer layer, and a silver (Ag) layer disposed on the carbon layer.

11. The tantalum capacitor of claim 1, wherein the tantalum body further includes a dielectric oxide layer disposed on a surface of the tantalum core.

12. The tantalum capacitor of claim 5, wherein the electrode layer directly contacts the tantalum core through the at least one opening.

13. The tantalum capacitor of claim 1, wherein the tantalum capacitor excludes a tantalum wire.

14. The tantalum capacitor of claim 13, wherein the anode portion directly contacts the tantalum body.

15. The tantalum capacitor of claim 1, wherein the electrode layer comprises at least one selected from the group consisting of tantalum (Ta), iron (Fe), and nickel (Ni).

16. A tantalum capacitor, comprising:
a tantalum body including a tantalum core and a conductive polymer layer disposed on the tantalum core;
a molded portion disposed to surround the tantalum body;
an anode portion disposed on one surface of the tantalum body, and including a dielectric and an electrode layer disposed within the dielectric; and
a cathode portion connected to the tantalum body, and spaced apart from the anode portion.

17. The tantalum capacitor of claim 16, wherein the electrode layer extends to one surface of the dielectric.

18. The tantalum capacitor of claim 16, wherein the tantalum body penetrates through a portion of the dielectric and is connected to the electrode layer.

19. The tantalum capacitor of claim 16, wherein the anode portion is a sintered anode portion.

20. The tantalum capacitor of claim 16, wherein the electrode layer is spaced apart from the molded portion.
